(19) United States
(12) Patent Application Publication
(10) Pub. No.: US 2011/0107774 A1
(43) Pub. Date: May 12, 2011

(54) Self-Powered Refrigeration Apparatus

(75) Inventor: Michael D. Newman, Hillsborough, NJ (US)

(73) Assignee: Linde Aktiengesellschaft, Munich (DE)

(21) Appl. No.: 12/617,156

(22) Filed: Nov. 12, 2009

(51) Int. Cl. F17C 9/04; F25D 17/06

(52) U.S. Cl. 62/50.3; 62/426

(57) ABSTRACT

A fan for refrigerant fluid, including at least one blade having an internal space through which a refrigerant fluid passes; at least one nozzle in fluid communication with the internal space of each blade, wherein the at least one nozzle discharges the refrigerant fluid at a velocity sufficient to rotate the blade(s); and an electrical generator operationally engaged with the blade(s). Also, a snow injection device for a CO₂ refrigerant fluid including a disk having an internal space through which a CO₂ refrigerant fluid passes; at least one nozzle in communication with the internal space which discharges the CO₂ refrigerant fluid at a velocity sufficient to rotate the disk, the nozzle(s) being adapted to flash the CO₂ refrigerant fluid into gas and solid phases; and an electrical generator operationally engaged with the disk. Also, refrigeration apparatus using the fan and/or snow injection device.

The present embodiments relate to fans used in refrigeration apparatus such as for example cryogenic food freezers.

Powering a fan in a refrigeration apparatus which utilizes a refrigerant fluid discharged directly into the refrigeration chamber requires use of electricity to operate an electric motor for the fan, the motor being mounted either internally or externally to the refrigeration chamber. Motors consume electrical energy and can add heat to the refrigeration apparatus if they are mounted to or within the refrigeration chamber. Further, internal injection headers required to distribute the refrigerant fluid into the refrigeration chamber consume electricity and produce additional unwanted heat within the chamber.

Such refrigeration apparatus may also have ancillary systems which require electrical energy, such systems to include, but are not limited to, conveying apparatus, thermostat devices, control systems, circulating fans and exhaust fans.

Therefore, what is needed is a fan and/or an injection device for refrigeration apparatus which is capable of converting the mechanical and/or kinetic energy of the refrigerant fluid into electrical energy which can be used to power various ancillary systems or for other purposes, and which is capable of distributing the refrigerant fluid into the refrigeration chamber without the addition of unwanted heat into the chamber.

For a more complete understanding of the present self-powered refrigeration apparatus, reference may be made to the following description of the self-powered refrigeration apparatus and particular embodiments thereof, in conjunction with the following drawings, of which:

FIG. 1 is a side plan view, partially in cross-section, of an embodiment of the fan for refrigerant fluid.

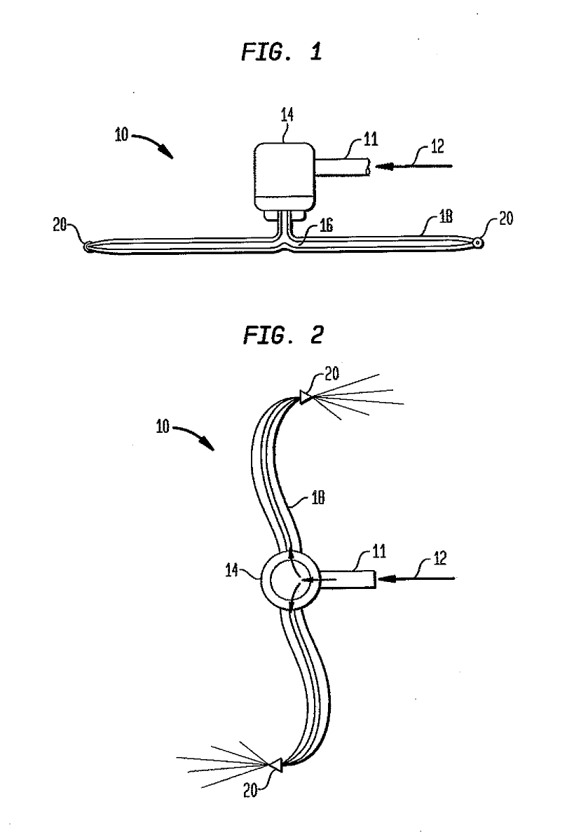

FIG. 2 is a top plan view in cross-section of the embodiment of FIG. 1.

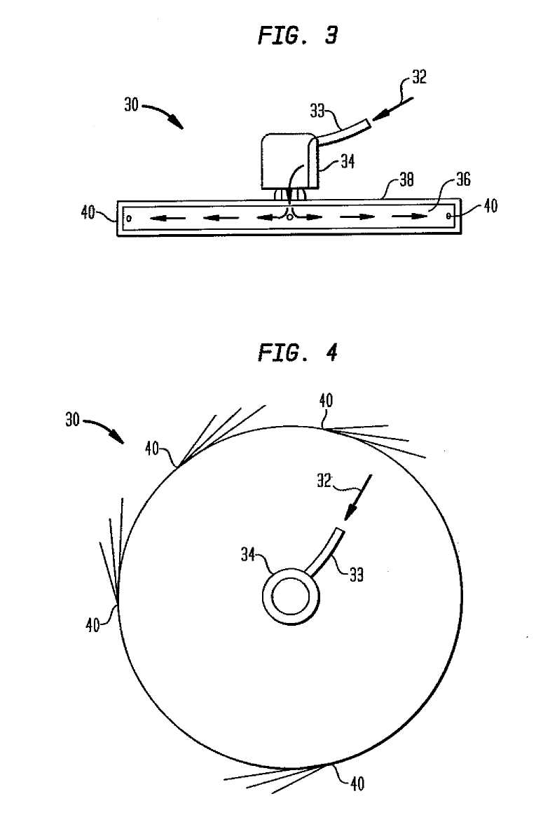

FIG. 3 is a side plan view, partially in cross-section, of an embodiment of a snow injection device.

FIG. 4 is a top plan view of the embodiment of FIG. 3.

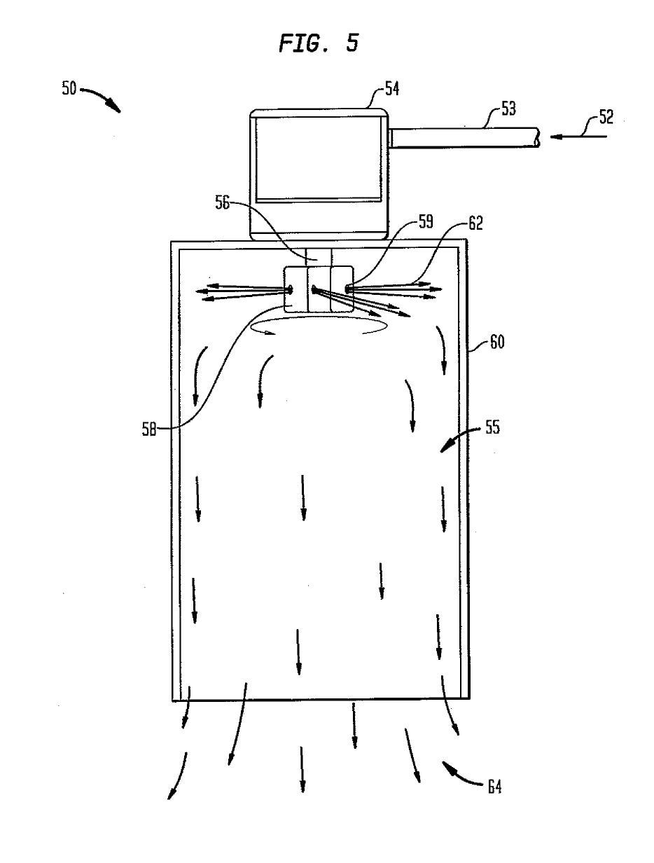

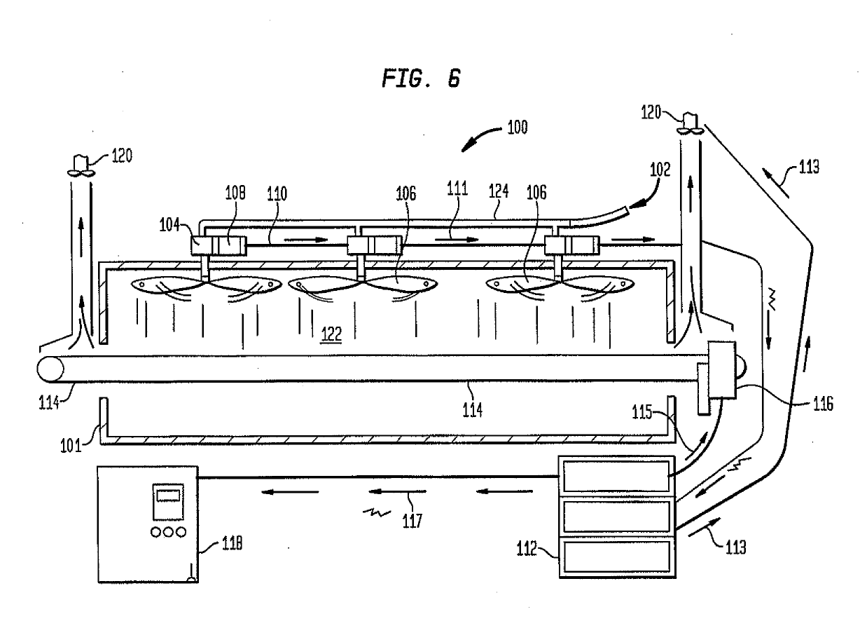

FIG. 5 is a side plan view, partially in cross-section, of another embodiment of a snow injection device.

FIG. 6 is a schematic side cut-away view of an embodiment of a self-powered refrigeration apparatus employing the fans as described herein.

The present refrigeration apparatus utilizes internal fans and/or snow injection devices capable of generating electrical energy.

The fan and snow injection device described herein are operable via energy provided by the refrigerant fluid. No motors are necessary to operate the fan or snow injection device. Energy may be removed from the refrigerant fluid by the fan or snow injection device, and that energy may be used to power the refrigeration apparatus. Since the refrigerant fluid provides energy to the fan or snow injection device, the fluid is delivered into the refrigeration apparatus with less energy, which results in a lower pressure of the refrigerant fluid, which in turn results in a greater cooling capacity per pound of refrigerant fluid supplied to the refrigeration apparatus. That is, the transfer of energy from the refrigerant fluid ultimately into electrical energy results in a lower energy state refrigerant fluid which increases the refrigerant capacity of the refrigerant fluid. Accordingly, a 15-20% improvement in refrigeration efficiency is realized by the present embodiments.

Provided is a fan for refrigerant fluid, comprising at least one blade having an internal space therein through which a refrigerant fluid passes; at least one nozzle in fluid communication with the internal space of the at least one blade, wherein the at least one nozzle discharges the refrigerant fluid from the at least one blade at a velocity sufficient to rotate the at least one blade; and an electrical generator operationally connected to the at least one blade. Alternatively, the fan may comprise a plurality of blades. The refrigerant fluid may be flashed into a mixture of solid and gaseous refrigerant as it is discharged from the at least one blade.

Also provided is a snow injection device for a carbon dioxide (CO₂) refrigerant fluid comprising a disk having an internal space therein through which a CO₂ refrigerant fluid passes; at least one nozzle in communication with the internal space within the disk which discharges the CO₂ refrigerant fluid from the disk at a velocity sufficient to rotate the disk, the at least one nozzle being adapted to flash the CO₂ refrigerant fluid into gas and solid phases; and an electrical generator operationally connected to the disk. Alternatively, the snow injection device may comprise a plurality of nozzles in communication with the internal space in the disk. The snow injection device may further comprise a shroud operatively associated with the snow injection device for causing the solid phase of the flashed CO₂ refrigerant fluid to fall at a reduced velocity out of the device, and into the refrigeration chamber.

The fan and/or snow injection device may further comprise means for storing electricity which are in direct or indirect electrical communication with the electrical generator. The above described nozzles may be high-velocity nozzles, and particularly may be supersonic nozzles.

Referring now to FIGS. 1 and 2, an embodiment of the fan shown generally at 10 includes a supply of refrigerant fluid 12, which enters a rotary union 14, proceeds through an internal space 16 of at least one blade 18 and is discharged through nozzle 20. The refrigerant fluid, which may be a cryogen fluid such as liquid carbon dioxide (CO₂), is delivered from a remote source (not shown) through a pipe 11 or conduit into the rotary union 14, the pipe 11 or conduit being in communication with the internal space 16 such that there is a flow of refrigerant fluid from the remote source through the pipe 11 or conduit and rotary union 14 into the internal space 16 of blade 18 or blades.

The blades 18 are engaged with the rotary union 14 such that the rotary union 14 remains stationary as the blades 18 rotate. The internal space 16 may operate as a conduit for the refrigerant fluid 12, or the internal space 16 may be sized and shaped to receive a conduit extending along the fan blade as shown. Such a conduit would be in fluid communication with the pipe 11. The nozzle 20 may be mounted to a tip of the blade 18 and is in fluid communication with the internal space 16 or conduit therein. The nozzle 20 may be a supersonic nozzle and may have its discharge orifice at a right angle with respect to the blade 18. Discharge speeds from the supersonic nozzle may be up to about Mach 3.

As the refrigerant fluid 12 enters the blade 18, it expands and performs work as it moves toward the nozzle 20, forcing the blade 18 to rotate. The nozzle 20 also increases the velocity of the exiting refrigerant fluid and further serves to increase the efficiency of the refrigerator. The refrigerant fluid 12, which may be CO₂, can be either a liquid or a gas as it passes through the blade 18, but upon discharge from the nozzle 20 it flashes into a solid and a gas. In certain embodiments, the fan for refrigerant fluid may additionally comprise one or more blades which do not have the internal spaces 16 therein.

The blades 18 may be operationally connected to or engaged with an electrical generator (not shown) which will function as a mechanical brake and will convert the kinetic energy of the rotating blades into electrical energy. The blades, as part of a rotor assembly, may be connected to the electrical generator, via a shaft and gear box. In certain embodiments, the shaft may be a low speed shaft that turns a gear which is adapted to turn a second gear connected to a high-speed shaft at a much faster speed than the low-speed shaft turns. The high-speed shaft turns a generator which is housed within a structure which provides a magnetic field. As the generator turns, the magnetic field is altered, thereby generating electricity.

Accordingly, electrical energy extracted from the rotating blades 18 by the electrical generator can be used directly or can be stored in energy storage devices such as capacitors or batteries to provide electrical energy to the ancillary systems of the refrigeration apparatus or for other purposes. Under testing and load conditions, a single fan 10 has been shown to generate in excess of 1.5 horsepower. As a result, while the fans do not require electrical energy in order to function, they can provide electrical energy for other components of the refrigeration apparatus which is converted from the kinetic energy of the refrigerant fluid. Thus, a refrigeration apparatus which is powered only by the refrigerant fluid may be provided.

For example, but without limitation, the electrical energy generated by the electrical generator may be used to power exhaust fans, conveyor motors, control panels, or other devices associated with the refrigeration apparatus. The electrical energy may be used to power devices or apparatus which are not part of the refrigeration apparatus, or such energy may be sent to the local electrical power grid.

Referring now to FIGS. 3 and 4, an embodiment of snow injection device 30 includes a supply of CO₂ refrigerant fluid 32 delivered in a pipe 33 or conduit, which enters a rotary union 34, proceeds through the internal space 36 of disk 38 and is discharged through the nozzles 40. For purposes of this embodiment, there may be one or a plurality of the nozzles 40, but for simplicity the at least one nozzle 40 is referred to in the plural. The disk 38 is engaged with the rotary union 34 such that the rotary union 34 remains stationary as the disk 38 rotates. The internal space 36 may operate as a conduit for the CO₂ refrigerant fluid 32 as shown, or the internal space 36 may be sized and shaped to receive a conduit or conduits extending along the disk. The internal space 36 would be in fluid communication with the pipe 33. The nozzles 40 are mounted to the periphery of the disk 38 and are in fluid communication with the internal space 36 or conduit therein. The nozzles 40 may be supersonic nozzles and may have discharge orifices at right angles with respect to the disk 38.

As the CO₂ refrigerant fluid 32 enters the disk 38, it expands and performs work as it moves toward the nozzles 40. The nozzles 40 may increase the velocity of the exiting refrigerant fluid and further serve to increase the efficiency of the refrigeration apparatus. The CO₂ refrigerant fluid 32 can be either a liquid or a gas as it passes through the disk 38, but upon discharge from the nozzles 40 it flashes into a solid and a gas. As the CO₂ refrigerant fluid is discharged from the nozzles 40 at a substantially tangential angle, the disk 38 is caused to rotate. At least one of the nozzles 40 is used to rotate the disk 38.

An electrical generator (not shown) may be disposed between the rotary union 34 and the disk 38, actuated by the rotation of the disk 38 as a rotor for the generator. The disk 38 may be operationally connected to or engaged with an electrical generator (not shown) which will function as a mechanical brake and will convert the kinetic energy of the rotating disk 38 into electrical energy. The disk 38, as part of a rotor assembly, may be connected to the electrical generator, in a manner as discussed with respect to the blades 18 in the embodiments of FIGS. 1 and 2.

Referring now to FIG. 5, another embodiment of a snow injection device 50 includes a supply of CO₂ refrigerant fluid 52, which enters the rotary union 54 through a pipe 53, proceeds through the threaded connection 56 and into the rotating element 58, where it flashes into a refrigerant discharge 62 of solid and gas. The rotating element 58 may be a disk or the like, but any shape that permits uniform rotation of the rotating element 58 may be employed. The refrigerant discharge 62 is exhausted into a chamber 55 defined by a shroud 60, and is substantially slowed in the chamber 55 so that a reduced or lower velocity snow 64 will be provided as the discharge exits the chamber 55. The rotating element 58 is engaged with the rotary union 54 such that the rotary union 54 remains stationary as the rotating element 58 rotates. The rotating element 58 may include one or more nozzles 59 which flash the refrigerant fluid into solid and gas. The nozzle(s) 59 of the rotating element 58 may be supersonic nozzles and may have discharge orifices at right angles with respect to the body of the rotating element 58.

The nozzle(s) of the rotating element 58 also increase the velocity of the exiting refrigerant fluid and further serve to increase the efficiency of the refrigerator. The CO₂ refrigerant fluid 52 can be either a liquid or a gas as it passes through the rotating element 58, but upon discharge from the rotating element 58 it flashes into a solid and a gas. As the CO₂ refrigerant fluid is discharged 62 from the rotating element 58 at a substantially tangential angle with respect to the body of the rotating nozzle 59, the rotating element 58 is caused to rotate.

An electrical generator may be disposed between the rotary union 54 and the rotating element 58, actuated by the rotation of the rotating element 58 as a rotor for the generator. The rotating element 58 may be operationally connected to or engaged with an electrical generator (not shown) which will function as a mechanical brake and will convert the kinetic energy of the rotating element 58 into electrical energy. The rotating element 58, as part of a rotor assembly, may be connected to the electrical generator, as discussed with respect to the embodiments of FIGS. 3 and 4. The embodiments of FIGS. 1-4 may be substituted for the rotating element 58.

FIG. 6 shows an embodiment of the present refrigeration apparatus comprising a tunnel freezer 100 employing fans 106 such as those shown in FIGS. 1 and 2. It will be understood that a single fan 106 may be present in the tunnel freezer 100, and that the fan(s) 106 of the tunnel freezer 100 may be substituted on an individual basis by snow injection devices, such as those shown in FIGS. 3-5.

The tunnel freezer 100 includes a housing 101 in which a freezing chamber 122 is provided and through which a conveyor 114 powered by a conveyor motor 116 moves to transfer products such as food products through the freezing chamber 122 of the tunnel freezer 100. At least one fan 106 is mounted in the freezing chamber 122. Each of the rotary unions 104 for a respective fan 106 is in fluid communication with a refrigerant conduit 124 which carries the refrigerant fluid 102, such as liquid CO₂ from a remote source (not shown). Each of the rotary couplings 104 is in mechanical communication with an electrical generator 108 which harvests the kinetic energy of the rotating fan 106 and converts it into electrical energy. The electrical generators 108 are in electrical communication with an electrical conduit 110 which may transfer the electrical energy, shown generally by arrows 111, generated by the electrical generators 108 to an electricity storage means 112, such as a battery. The electrical energy stored in the storage means 112 may be used to provide electrical energy, shown generally by arrows 113, to an exhaust fan 120, the conveyor motor 116 as shown generally by arrow 115, and/or a control panel 118 as shown generally by arrows 117. The control panel 118 may monitor the operation of the tunnel freezer 100, including the electricity generated by the fan/generator assemblies and the electrical load stored by the storage means 112.

The refrigerant fluid referred to in the above tunnel freezer and fan embodiments may be CO₂, nitrogen (N₂), or air, each of which may be either in liquid or gas form, or a mixture thereof. Liquid air may be provided as the result of blending or mixing liquid N₂ and liquid oxygen (O₂).

When liquid CO₂ is used as the refrigerant fluid, the fan and disk embodiments discussed above may reduce the pressure of the liquid CO₂ before it is discharged from the fan. This reduction in pressure results in a reduction in the energy state of the CO₂, which increases the solid to gas proportion of the CO₂ when it is discharged from the nozzle(s) of the fan or disk.

It has been shown that the solid proportion of CO₂ discharged from the present fan embodiments may be from about 52% to about 57%, whereas traditional, stationary injection devices typically realize a solid proportion of from about 47% to about 48%. Without wishing to be limited by theory, it is believed that when using traditional, stationary injection devices, much of the potential energy contained in the liquid CO₂ is converted into heat, which provides 47-48% solid CO₂ upon flashing into a lower pressure volume. When utilizing the present fan embodiments, energy is removed from the liquid CO₂ in order to perform work to rotate the devices. This results in a decreased pressure of the liquid CO₂ which is accompanied by a decrease in temperature. Because the temperature and pressure of the liquid CO₂ are lower, about 52-57% solid CO₂ is produced upon flashing. Additionally, the energy produced by the rotation of the present fans may be utilized for other purposes. An increased proportion of solid created by the present fans increases the efficiency of a refrigeration system in which the fans are used, because the solid CO₂ provides better heat transfer than does the gaseous CO₂.

Therefore, a self-powered refrigeration apparatus is provided, comprising a refrigeration chamber and at least one fan, comprising at least one blade having an internal space therein through which a refrigerant fluid passes; at least one nozzle in fluid communication with the internal space within each of the at least one blade, wherein the at least one nozzle discharges the refrigerant fluid into the refrigeration chamber at a velocity sufficient to rotate the at least one blade; and an electrical generator operationally connected to the plurality of blades. Alternatively, the fan may comprise a plurality of blades.

Also provided is a self-powered refrigeration apparatus, comprising a refrigeration chamber and at least one snow injection device, comprising a disk having an internal space therein through which a CO₂ refrigerant fluid passes; at least one nozzle in communication with the internal space within the disk which discharges the CO₂ refrigerant fluid from the disk at a velocity sufficient to rotate the disk, the at least one nozzle being adapted to flash the CO₂ refrigerant fluid into gas and solid phases and eject the gas and solid phases into the refrigeration chamber; and an electrical generator operationally connected to the disk. Alternatively, the snow injection device may comprise a plurality of nozzles.

It will be understood that the embodiments described herein are merely exemplary and that a person skilled in the art may make many variations and modifications without departing from the spirit and scope of the invention. All such variations and modifications are intended to be included within the present embodiments as described and claimed herein. It should be understood that the embodiments described above are not only in the alternative, but may be combined.

What is claimed is:

1. A fan for refrigerant fluid, comprising:
at least one blade having an internal space therein through which a refrigerant fluid passes;
at least one nozzle in fluid communication with the internal space of the at least one blade, wherein the at least one nozzle discharges the refrigerant fluid from the at least one blade at a velocity sufficient to rotate the at least one blade; and
an electrical generator operationally connected to the at least one blade.

2. The fan of claim 1, further comprising means for storing electricity in electrical communication with the electrical generator.

3. The fan of claim 1, wherein the at least one nozzle is a supersonic nozzle.

4. The fan of claim 3, wherein the refrigerant fluid is flashed into a mixture of solid and gaseous refrigerant as it is discharged from the at least one blade.

5. A snow injection device for a CO₂ refrigerant fluid comprising:
a disk having an internal space therein through which a CO₂ refrigerant fluid passes;
at least one nozzle in communication with the internal space within the disk which discharges the CO₂ refrigerant fluid from the disk at a velocity sufficient to rotate the disk, the at least one nozzle being adapted to flash the CO₂ refrigerant fluid into gas and solid phases; and
an electrical generator operationally connected to the disk.

6. The snow injection device of claim 5, further comprising means for storing electricity in electrical communication with the electrical generator.

7. The snow injection device of claim 5, wherein the at least one nozzle is a supersonic nozzle.

8. A self-powered refrigeration apparatus comprising a refrigeration chamber and at least one fan, comprising:
at least one blade having an internal space therein through which a refrigerant fluid passes;
at least one nozzle in fluid communication with the internal space of the at least one blade, wherein the at least one nozzle discharges the refrigerant fluid into the refrigeration chamber at a velocity sufficient to rotate the at least one blade; and
an electrical generator operationally connected to the at least one blade.

9. The self-powered refrigeration apparatus of claim 8, further comprising means for storing electricity in electrical communication with the electrical generator.

10. The self-powered refrigeration apparatus of claim 8, further comprising at least one conveyor disposed for movement in the refrigeration chamber, and optionally means for storing electricity in electrical communication with the electrical generator, wherein the at least one conveyor comprises a motor in electrical communication with at least one of the electrical generator or the means for storing electricity.

11. The self-powered refrigeration apparatus of claim 10, further comprising a control panel in electrical communication with the electrical generator and the at least one conveyor.

12. The self-powered refrigeration apparatus of claim 11, further comprising at least one exhaust fan in fluid communication with the refrigeration chamber, the at least one exhaust fan being in electrical communication with the control panel and at least one of the electrical generator or the means for storing electricity.

13. The self-powered refrigeration apparatus of claim 8, wherein the at least one nozzle is a supersonic nozzle.

14. A self-powered refrigeration apparatus comprising a refrigeration chamber and at least one snow injection device, comprising:
a disk having an internal space therein through which a CO₂ refrigerant fluid passes;
at least one nozzle in communication with the internal space within the disk which discharges the CO₂ refrigerant fluid from the disk at a velocity sufficient to rotate the disk, the at least one nozzle being adapted to flash the CO₂ refrigerant fluid into gas and solid phases and eject the gas and solid phases into the refrigeration chamber; and
an electrical generator operationally connected to the disk.

15. The self-powered refrigeration apparatus of claim 14, further comprising means for storing electricity in electrical communication with the electrical generator.

16. The self-powered refrigeration apparatus of claim 14, further comprising at least one conveyor disposed for movement in the refrigeration chamber, and optionally means for storing electricity in electrical communication with the electrical generator, wherein the at least one conveyor comprises a motor in electrical communication with at least one of the electrical generator or the means for storing electricity.

17. The self-powered refrigeration apparatus of claim 16, further comprising a control panel in electrical communication with the electrical generator and the at least one conveyor.

18. The self-powered refrigeration apparatus of claim 17, further comprising at least one exhaust fan in fluid communication with the refrigeration chamber, the at least one exhaust fan being in electrical communication with the control panel and at least one of the electrical generator or the means for storing electricity.

19. The self-powered refrigeration apparatus of claim 14, wherein the at least one nozzle is a supersonic nozzle.

20. The self-powered refrigeration apparatus of claim 14, further comprising a shroud operatively associated with the snow injection device for causing the solid phase of the flashed CO₂ refrigerant fluid to fall at a reduced velocity into the refrigeration chamber.
